(19) United States
(12) Patent Application Publication
(10) Pub. No.: US 2023/0098134 A1
(43) Pub. Date: Mar. 30, 2023

(54) SEWAGE TREATMENT DEVICE AND SYSTEM

(71) Applicant: Zhiwei CHEN, Changsha (CN)

(72) Inventor: Zhiwei CHEN, Changsha (CN)

(21) Appl. No.: 17/964,846

(22) Filed: Oct. 12, 2022

Related U.S. Application Data
(63) Continuation of application No. PCT/CN2021/117950, filed on Sep. 13, 2021.

(30) Foreign Application Priority Data
Sep. 13, 2020 (CN) 202010958126.5

(51) Int. Cl. C02F 1/00; C02F 1/68

(52) U.S. Cl. CPC C02F 1/004; C02F 1/685; C02F 1/008; C02F 2301/08; C02F 2201/002

(57) ABSTRACT

The present disclosure discloses a sewage treatment device and system, comprising a container, a filter element, a filter element lifting mechanism, a liquid inlet mechanism, an agent administration mechanism, a liquid pumping mechanism, and a material discharge mechanism; the sewage treatment device and system further comprise a control module, wherein the control module is used for controlling the actions of the filter element lifting mechanism, the liquid inlet valve, the agent administration mechanism, the liquid pumping mechanism, and the material discharge valve; the container is an outer barrel. The present disclosure enables circulating water treatment with high water treatment efficiency.

### CROSS-REFERENCE TO RELATED APPLICATIONS

The application claims priority to Chinese patent application No. 202010958126.5, filed on Sep. 13, 2020, the entire contents of which are incorporated herein by reference.

### TECHNICAL FIELD

The present disclosure relates to a sewage treatment device and system.

### BACKGROUND

The existing water treatment devices and systems typically employ one-stage or multi-stage settling tanks, suffering from the following disadvantages.

(1) Large Area Occupation

The settling tank requires a large area and a large amount of engineering.

(2) Extensive Process and Low Efficiency

Manual management is adopted to specifically manage how to feed water, how to administrate agents, how to discharge water, how to discharge wastes, etc. The operation is complicated, and it belongs to extensive management and cannot be refined for sewage or water purification treatment.

(3) High Cost

High equipment cost, high labor cost, large investment, inconvenient movement, and poor flexibility.

Therefore, it is necessary to design anew sewage treatment device and system.

### SUMMARY

The technical problem to be solved by the present disclosure is to provide a sewage treatment device and system. The sewage treatment device and system have an automatic lifting filter element, a high degree of automation, and a high water treatment efficiency.

The technical solutions of the disclosure are as follows.

A sewage treatment device and system are provided, comprising a container, a filter element, a filter element lifting mechanism, a liquid inlet mechanism, an agent administration mechanism, a liquid pumping mechanism, and a material discharge mechanism;

wherein the filter element is placed in the container; the filter element is hollow, the outer wall is provided with multiple filter holes, and the filter element is used for filtering clear liquid from the container into the filter element;

the filter element lifting mechanism comprises a lifting platform and an electrically controlled lifting driving mechanism; the lifting platform is connected to the filter element for driving the filter element to rise and lower; the electrically controlled lifting driving mechanism is connected to the lifting platform for driving the lifting platform to perform rising and lowering actions in the container, or to perform rising and lowering actions in the container and above the container;

the liquid inlet mechanism is used for introducing sewage to be treated into the container, and a liquid inlet valve is provided on a liquid supplying pipeline of the liquid inlet mechanism;

the agent administration mechanism is used for administrating a water treatment agent into the container, and the water treatment agent is used for reacting with sewage in the container to generate floccules; the agent administration opening of the agent administration mechanism is provided in the container, or above the container, for example, the agent administration pipe can extend into the container through the outer wall of the container;

the material discharge mechanism further comprises a discharge pipe provided at a bottom of the container for discharging wastes and a material discharge valve provided on the discharge pipe;

the liquid pumping mechanism comprises a liquid pump and a water pumping pipe connected to the liquid pump, wherein a lower end of the water pumping pipe is located at the bottom within the filter element for pumping out the clear liquid in the filter element;

the sewage treatment device and system further comprises a liquid level detection module for detecting a liquid level of the container;

the sewage treatment device and system further comprises a control module, wherein the control module is used for controlling actions of the filter element lifting mechanism, the liquid inlet valve, the agent administration mechanism, the liquid pumping mechanism, and the material discharge valve;

the container is an outer barrel.

The filter element is a rotary filter element; the rotary filter element means that the filter element can rotate relative to the lifting platform driven by an external force;

the moving direction of the electrically controlled lifting driving mechanism is the same as the axial direction of the filter element;

A bearing is provided on the lifting platform, and a rotary shaft (6) of the filter element is inserted and installed on the bearing; the lifting platform is further provided with a motor (13) for driving the rotation of the rotary shaft.

The filter element is a fixed filter element. The fixed filter element means that the filter element is directly fixed to the lifting platform, moves synchronously with the lifting platform, and does not rotate relative to the lifting platform itself.

The liquid pump is provided on the lifting platform.

The liquid pump is an external liquid pump, the liquid pump being provided on the ground outside an outer barrel or the liquid pump being provided on a support on the ground.

The filter element is a cylindrical filter element;

the liquid inlet mechanism is an annular water inlet pipe, and multiple water outlet holes are provided on the annular water inlet pipe; the annular water inlet pipe is located at an opening of the container; the diameter of the annular water inlet pipe is greater than an outer diameter of the filter element.

A stationary part of the electrically controlled lifting driving mechanism is fixed to the container, to the ground, or to an external support.

At least two electrically controlled lifting driving mechanisms are provided.

The bottom of the outer barrel is provided with an under-chassis for supporting.

The agent administration mechanism comprises a medical solution barrel, an agent administration pipe, and an agent administration pump, wherein the agent administration pump is for pumping the liquid in the medical solution barrel into the container through the agent administration pipe, and the agent administration pump is controlled by the control module.

Multiple barrel-type water treatment devices are included, multiple barrel-type water treatment devices being cascaded; the cascaded refers to that fresh water extract from the barrel-type water treatment device of a preceding stage enters the liquid inlet mechanism of the next stage or enters the liquid inlet mechanism of the next stage after being buffered by an intermediate tank; in addition, a water treatment agent is added before water treatment in each stage of the tank-type water treatment device.

The administration can be carried out by an additional pipe, or by direct administration of solid or powdered agents, or by the administration of solutions with agents.

A detection module for detecting the volume or liquid level of the liquid in the container is provided in the container; the detection module is a liquid level detection sensor or a pressure sensor, and the pressure detected based on the pressure sensor can also be converted into a liquid level.

The detection module can directly use a liquid level sensor, such as a photoelectric liquid level sensor, or use other sensors to convert the same into a liquid level, such as using a flow meter at the water inlet pipe and converting the same into a liquid level through the flow and the cross-sectional area of the container, and also can convert the same into a liquid level through the hydraulic data collected by the pressure sensor, because the pressure at the bottom of the liquid is directly proportional to the liquid level.

The intelligent water treatment device further comprises a control module, wherein the control module is used for controlling the actions of a filter element lifting mechanism, a liquid inlet valve, an agent administration mechanism, a liquid pumping mechanism, and a material discharge valve. The detection module is connected to the control module for transmitting the detection result to the control module. The specific control module and control method are the prior art.

The control module may be a relay control module, or a control module based on an MCU, wherein the MCU is a single-chip microcomputer, a PLC, an ARM processor or a DSP.

For the sake of balance, at least two electrically controlled lifting driving mechanisms are provided; the stationary part of the electrically controlled lifting driving mechanism is fixed to the container or to an external support or to the ground. In this way, the structure is compact, and the whole equipment forms integrated equipment. The electrically controlled lifting driving mechanism comprises a stationary part and a moving part; in operation, the stationary part does not operate, and the moving part telescopically operates.

The liquid inlet pipe is an annular liquid inlet pipe, multiple water outlet holes are provided on the pipe wall of the liquid inlet pipe, and the annular liquid inlet pipe is located at the opening of the container; the diameter of the annular liquid inlet pipe is greater than the outer diameter of the filter element.

The liquid inlet pipe is fixed to or in the container; the diameter of the inner ring of the annular pipe is greater than the outer diameter of the filter element; it is ensured that the filter element can be lifted and lowered on the annular pipe so that the water out of the annular pipe can clean the outer wall of the filter element.

The rotary shaft is a hollow rotary shaft, and the water pumping pipe is located in the through hole of the rotary shaft. The water pumping pipe may be separately provided outside the rotary shaft, and correspondingly, the rotary shaft may not be hollow.

The liquid pump is provided on the ground outside the outer barrel, or on the support provided on the ground.

The container is an outer barrel, and the bottom of the outer barrel is provided with an under-chassis for supporting.

The container may also be a treatment tank.

The inside of the container is provided with a liquid level detection module; the liquid level detection module can directly use a liquid level sensor, or use other sensors to convert the same into a liquid level, such as using a flow meter at the water inlet pipe to convert the same into a liquid level through the flow and the cross-sectional area of the container, or also convert the same into a liquid level through the hydraulic data collected by a pressure sensor; since the pressure at the bottom of the liquid is directly proportional to the liquid level, the liquid level detection module preferably uses a liquid level sensor, and the liquid level sensor is connected to the controller. The liquid level sensors are preferably two in number, one being installed at a higher end of the container for detecting the highest water level, and one being installed at a lower end of the container for detecting the lowest water level.

A flow sensor is provided at the water outlet pipe, and the flow sensor is connected to the controller.

A magnetic levitation reverse water collector is provided at the bottom of the filter element, and the magnetic levitation reverse water collector is located outside the filter element. When water is provided, the magnetic levitation reverse water collector closes the pipeline of the magnetic levitation reverse water collector under the action of buoyancy; when no water is provided, the channel is opened, and impurities are discharged from the pipe orifice.

Water treatment agents are such as coagulants, flocculating agents, color removers, and the like.

When the water enters, the waste water ejects from the water outlet hole to clean the outer wall of the filter element, and the water outlet hole is designed to be inclined at a certain angle so that the cleaning effect is better than before. In particular, the angle of inclination is 1-30 degrees, preferably 10-20 degrees, such that the angle of the outlet water deviates from the radial direction by a certain angle, such as 10-20 degrees.

The up-down position detection module, such as an up-down travel switch or a displacement sensor, etc. may or may not be provided. Because the electrically controlled push rod mechanism may have its own journey detection, or may stop itself after reaching the maximum limit, such as stopping after extending to the maximum position, or stopping after retracting to the shortest position.

With regard to the rotary filter element, when the filter element lowers, the rotation thereof can be controlled, and the rotation of the filter element can agitate the liquid and play a stirring role.

A sewage treatment device comprises a container (21), a support, a lifting water treatment unit, a liquid inlet mechanism, an agent administration mechanism, and a material discharge mechanism; at least one lifting water treatment unit is provided to hang on a support; the support is located above the container; the liquid inlet mechanism is used for introducing the sewage to be treated into the container, and a liquid inlet valve is provided on a liquid supplying pipeline of the annular water inlet pipe; an agent administration mechanism is used for administrating the water treatment agent into the container; a material discharge mechanism is used for discharging waste at the bottom of the container; the material discharge mechanism comprises a discharge pipe and a material discharge valve provided on the discharge pipe; the inlet of the discharge pipe is arranged at the bottom of the container; the lifting water treatment unit comprises a filter element, a filter element lifting mechanism, and a liquid pumping mechanism; the filter element is placed in the container; the filter element is hollow, and the outer wall is provided with multiple filter holes, and the filter element is used for filtering clear liquid from the container into the filter element; the filter element lifting mechanism comprises a lifting platform and an electrically controlled lifting driving mechanism (17); an electrically controlled lifting driving mechanism serves as a connecting mechanism between the support and the lifting platform; the electrically controlled lifting driving mechanism is used for driving the lifting platform to rise and lower; the filter element is installed on the lifting platform; the liquid pumping mechanism comprises a liquid pump (2) and a water pumping pipe (3) connected to the liquid pump, wherein the lower end of the water pumping pipe is located at the bottom of the filter element for pumping out the clear liquid in the filter element; the sewage treatment device further comprises a liquid level detection module for detecting the liquid level of the container; the sewage treatment device further comprises a control module, wherein the control module is used for controlling the actions of the filter element lifting mechanism, the liquid inlet mechanism, the agent administration mechanism, the liquid pumping mechanism, and the material discharge valve; the container is a box or a tank.

The number of both the lifting water treatment units and liquid inlet mechanisms is N, N being an integer, and N≥1.

The sewage treatment device according to claim 2 is provided, characterized in that the liquid inlet mechanism is an annular water inlet pipe, and multiple water outlet holes are provided on the annular water inlet pipe; an annular water inlet pipe is located at the opening of the container; the diameter of the annular water inlet pipe is greater than the outer diameter of the filter element; the annular water inlet pipe is fixed below the support via a vertical rod (63); when the filter element rises, the filter element can pass up through the annular water inlet pipe, so that the liquid ejected from the annular water inlet pipe can flush the outer wall of the filter element when the filter element rises. The filter element is a cylindrical filter element.

### Beneficial Effects

The sewage treatment device and system of the present disclosure have the following features:

1. Compact structure and integral structure; small space occupation; easy to move;

wherein the container may be a generally circular outer barrel, or a fixed or movable container of rectangular solid or cuboid type, the latter being capable of containing multiple filter elements; outriggers can be set at the bottom of the container, making it easy to move; with small room occupation.

2. Automatic operation; can be unattended; remote monitoring;

wherein under the control of a controller, the equipment can operate automatically and can be unattended; after the controller is connected with a communication module, remote control can be realized; the field data can be transmitted to a remote server or a data terminal (such as a smart phone) such that remote monitoring can be realized; therefore, the degree of automation is high and the degree of digitization is high;

a simulated relay control system can also be used to realize the control which is existing mature technology.

3. Adopting the modular concept and operating with a modular mode;

wherein it can be flexibly connected in parallel or in cascade; modular operation facilitates the later maintenance.

4. Having self-cleaning function;

the whole process flow, the structure, and the design concept are clever; with strong processing capacity;

on the annular water inlet pipe, the hole has a certain slope, so as to better flush the outer wall of the inner barrel and clean the residual flocculent matter on the inner barrel; the tricky part is that when the filter element rises, it also rotates at the same time, and can clean the filter element under the impact of water inflow at the same time, thus avoiding an additional cleaning process; as the filter element is rotated down, the liquid (water and agent to be treated) in the container is stirred well; if it does not rotate, it can also act as a flush if the holes of the water jets are sufficiently dense;

the whole process flow is easy to control, can collect various parameters, and act according to the collected parameters, so the processing efficiency is high; through self-inspection, equipment failure warning, network control, and remote parameter collection can be realized, and the automatic monitoring of water quality data such as COD and BOD can be realized.

5. The sealing can be good to avoid secondary pollution;

with this device, the waste water is not exposed to the outside, avoiding secondary pollution.

6. The ultraviolet sterilization and ozone sterilization can be further added to the water outlet pipe;

the device and system can be used to treat sewage, and can also be used to purify water from water plants with wide applications;

the mesh number of the filter element can be set as required, and the larger the mesh number, the fine filtration can be achieved;

in addition, different treatments are carried out depending on different agents administered in the water;

the liquid level sensor may be a magnetic sensor (Hall sensor) or an optical sensor (such as an infrared correlation tube, etc.).

7. The external liquid pump enables the load of the lifting platform to be smaller than that of the liquid pump provided on the lifting platform, so that significant energy saving can be achieved, and a motor with smaller power can be selected for the motor, thus reducing the costs. The liquid pump may also be provided on the lifting platform (not shown in the figure).

8. The scheme of using multiple water treatment units is suitable for treating large amounts of sewage at once; the electrically controlled lifting driving mechanism drives multiple water treatment units to rise and lower synchronously, and the movable end (lower end) is connected to the lifting platform, so that the synchronous lifting of multiple filter elements can be realized; with this mode, the amount of treated water per unit time can be greatly increased, and the efficiency can be multiplied, such as 4 times, 10 times, or even 100 times that of a common single filter element.

The core features of the present disclosure are: automatic lifting (lifting function, cleaning filter element, and circulation action), self-cleaning, purifying waste water by filtration, circulation action;

in summary, the sewage treatment device and system of the present disclosure have a high degree of automation, can achieve a refined treatment of sewage or water to be purified, are easy to implement, have a compact structure, are easy to move and combine flexibly, are a significant improvement to the existing water treatment equipment, and have great social and economic benefits.

### BRIEF DESCRIPTION OF DRAWINGS

FIG. 1 is a schematic view (front view) of a structure of a barrel-type water treatment device having an external liquid pump and a rotary filter element when a filter element is located at the lowermost end;

FIG. 2 is a schematic view (side view) of the structure of a barrel-type water treatment device having an external liquid pump and a rotary filter element when a filter element is located at the lowermost end;

FIG. 3 is a schematic view (side view) of the structure of a barrel-type water treatment device having an external liquid pump and a rotary filter element when a filter element is located at the uppermost end;

FIG. 4 is a schematic view (front view) of the structure of a barrel-type water treatment device having an external liquid pump and a rotary filter element when a filter element is located at the lowermost end;

FIG. 5 is a schematic view (perspective view) of the structure of an annular water inlet pipe;

FIG. 6 is a schematic view (perspective view) of a filter element frame;

FIG. 7 is a schematic view (front view) of a filter element frame;

FIG. 8 is a schematic view (top view) of a filter element frame;

FIG. 9 is a schematic view showing the structure of a filter element lifting mechanism propped up by a support;

FIG. 10 is a schematic view showing a structure in which multiple filter elements share one support mechanism;

FIG. 11 is a flowchart of relay control;

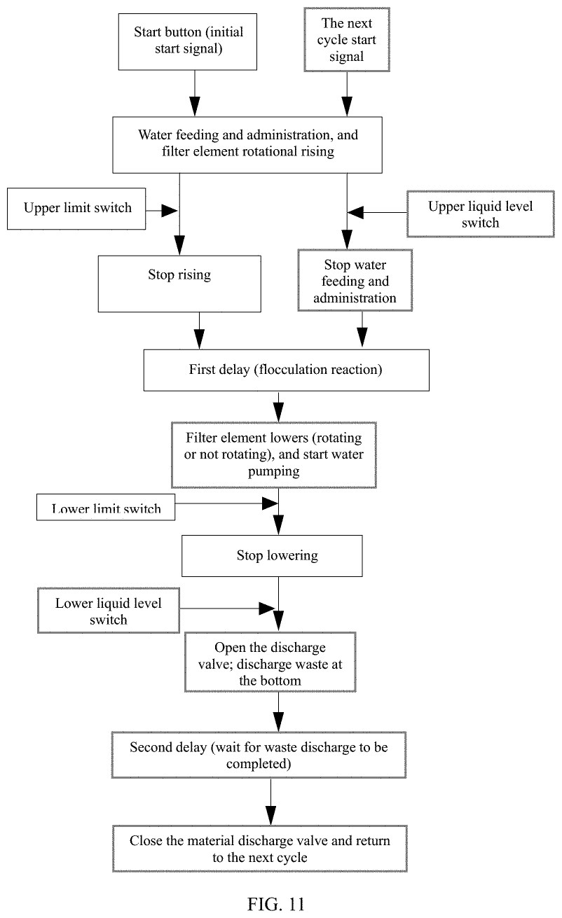

FIG. 12 is a block diagram of a control system;

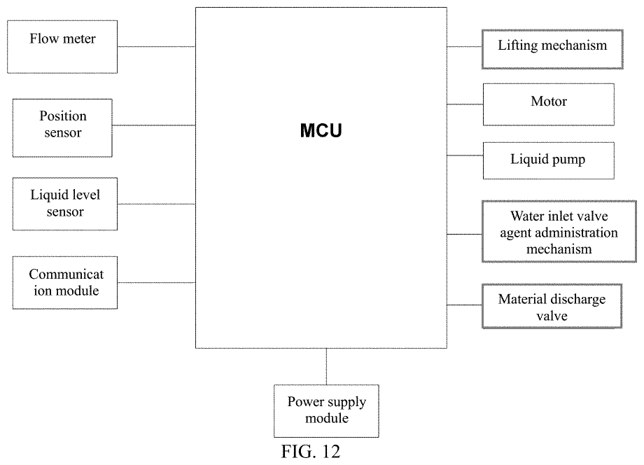

FIG. 13 is a schematic view of a structure of a cascade of a water treatment device (a filter element at the lowermost end);

FIG. 14 is a schematic view of an external structure of a cascade of three water treatment devices (the filter element at the lowermost end);

FIG. 15 is a schematic view of a stereostructure of a cascade of three water treatment devices (a filter element at the lowermost end);

FIG. 16 is a schematic view of the structure of a barrel-type water treatment device having an external liquid pump and a lifting filter element when a filter element is located at the lowermost end (using a connecting rod to connect the filter element to a lifting platform);

FIG. 17 is a schematic view showing the structure of a barrel-type water treatment device having an external liquid pump and a lifting filter element when a filter element is located at the uppermost end (using a connecting rod to connect the filter element to a lifting platform);

FIG. 18 is a schematic view showing the structure of a barrel-type water treatment device having an external liquid pump and a lifting filter element when a filter element is located at the lowermost end (using a connecting rod and a central pipe to connect the filter element to a lifting platform).

FIG. 19 is a schematic view of a deep process docking of a water treatment module (device) with a subsequent stage;

FIG. 20 is a schematic view showing a detection result of the water quality;

FIG. 21 is a schematic view (front view) of the structure of an intelligent water treatment device having a rotary filter element when the filter element is at the lowermost end;

FIG. 22 is a schematic view (side view) of the structure of an intelligent water treatment device having a rotary filter element when the filter element is at the lowermost end;

FIG. 23 is a schematic view (side view) of the structure of an intelligent water treatment device having a rotary filter element when the filter element is at the uppermost end;

FIG. 24 is a schematic view (front view) of the structure of an intelligent water treatment device having a rotary filter element when the filter element is at the lowermost end;

FIG. 25 is a schematic view (top view) of a structure in which multiple filter elements share one support mechanism;

FIG. 26 is a schematic view of the structure of an intelligent water treatment device having a non-rotary filter element when the filter element is at the lowermost end (using a connecting rod to connect the filter element to a lifting platform);

FIG. 27 is a schematic view of the structure of an intelligent water treatment device having a non-rotary filter element when the filter element is at the uppermost end (using a connecting rod to connect the filter element to a lifting platform);

FIG. 28 is a schematic view of the structure of an intelligent water treatment device having a non-rotary filter element when the filter element is at the lowermost end (using a connecting rod and a central pipe to connect the filter element to a lifting platform);

FIG. 29 is a schematic view of multiple water treatment units arranged in an array of 2 rows and 3 columns in the same container.

### DETAILED DESCRIPTION OF THE EMBODIMENTS

The present disclosure will be described below in further detail with reference to the accompanying drawings and specific embodiments.

### Embodiment 1

(I) A Barrel-Type Water Treatment Device Having an External Liquid Pump and a Rotary Filter Element

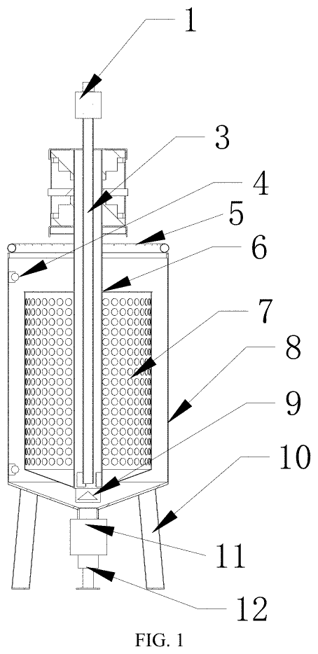

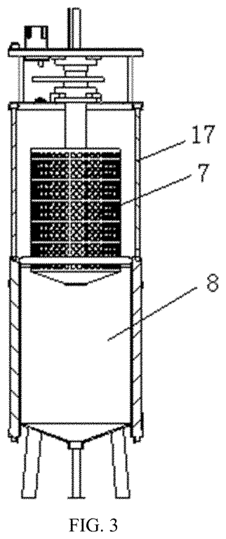

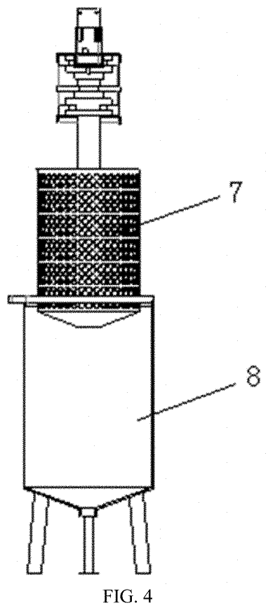

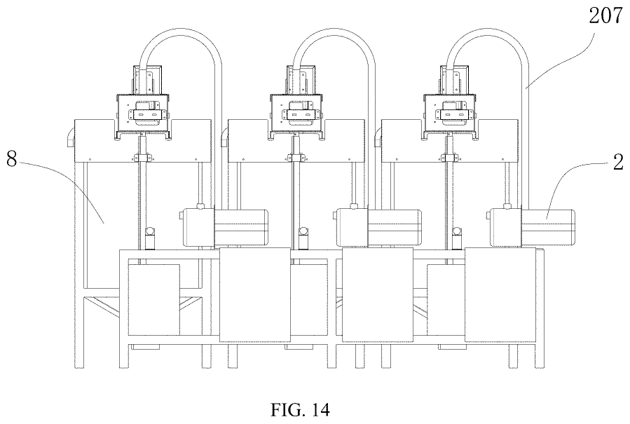

As shown in FIGS. 1-4, a barrel-type water treatment device having an external liquid pump and a rotary filter element comprises a container (specifically an inner barrel 8), a filter element 7, a filter element lifting mechanism, a liquid inlet pipe 5, an agent administration mechanism, a liquid pumping mechanism, and a material discharge mechanism; a filter element is placed in the container; multiple filter holes are provided on the barrel wall of the filter element; the filter element is a rotary filter element; the filter element lifting mechanism comprises a lifting platform and an electrically controlled lifting driving mechanism 17; the electrically controlled lifting driving mechanism is fixed to the container, or on the ground, or on other supports, and is connected with the lifting platform; the moving direction of the electrically controlled lifting driving mechanism is the same as the axial direction of the filter element; the electrically controlled lifting driving mechanism can also be a hydraulic push rod or an electric push rod; a bearing is provided on the lifting platform, and the rotary shaft 6 of the filter element is inserted on the bearing; the lifting platform is further provided with a motor 13 for driving the rotation of the rotary shaft and a transmission mechanism; the lifting platform is connected to the filter element for driving the filter element to rise and lower; the liquid inlet pipe is used for introducing water to be purified into the container, and a liquid inlet valve is provided on a liquid supplying pipeline of the liquid inlet pipe; the liquid outlet of the administration mechanism is arranged in or above the container for administrating the water treatment agent into the container; the dosing may be carried out by an additional pipe, or by direct dosing of the solid or powdered agent; the discharge mechanism comprises a discharge pipe 12 provided at the bottom of the container for discharging wastes and a material discharge valve 11 provided on the discharge pipe; the liquid pumping mechanism comprises a liquid pump 2 and a water pumping pipe 3 connected to the liquid pump, wherein the lower end of the water pumping pipe is located at the bottom within the filter element for pumping out the filtered water in the filter element. The liquid pump is preferably a self-priming water pump. The liquid pump is an external liquid pump; see FIGS. 14-16.

A liquid level detection module is provided on the container; the liquid level detection module can directly use a liquid level sensor, or use other sensors to convert the same into a liquid level, such as using a flow meter at the water inlet pipe and converting the same into a liquid level through the flow and the cross-sectional area of the container, or also convert the same into a liquid level through the hydraulic data collected by the pressure sensor, because the pressure at the bottom of the liquid is directly proportional to the liquid level; the intelligent water treatment device further comprises a control module, wherein the control module is used for controlling the actions of the filter element lifting mechanism, the liquid inlet valve, the liquid pumping mechanism, and the material discharge valve. The control module can be a relay control module or a control module based on an MCU. The MCU is a single chip microcomputer, a PLC, an ARM processor or a DSP; at least two electrically controlled lifting driving mechanisms are provided; the stationary part of the electrically controlled lifting driving mechanism is secured to the container or to an external support. In this way, the structure is compact, the whole equipment forms integrated equipment, and the electrically controlled lifting driving mechanism comprises a stationary part and a moving part; when operating, the stationary part does not operate, and the moving part telescopically operates; the liquid inlet pipe is an annular liquid inlet pipe, multiple water outlet holes are provided on the pipe wall of the liquid inlet pipe, and the annular liquid inlet pipe is located at the opening of the container and is fixed to the inner wall of the container; the diameter of the annular liquid inlet pipe is greater than the outer diameter of the filter element. The liquid inlet pipe is fixed to the container; the diameter of the inner ring of the annular pipe is greater than the outer diameter of the filter element; it is ensured that the filter element can be lifted and lowered on the annular pipe, so that the water out of the annular pipe can clean the outer wall of the filter element; the rotary shaft is a hollow rotary shaft, and the water pumping pipe is located in a through hole of the rotary shaft.

The liquid pump is provided on the ground outside the outer barrel, or on a support provided on the ground.

The container is an outer barrel, and the bottom of the outer barrel is provided with an under-chassis 10 for supporting.

The inner wall of the container is provided with a liquid level detection module; the liquid level detection module can directly use a liquid level sensor, or use other sensors to convert the same into a liquid level, such as using a flow meter at the water inlet pipe to convert the same into a liquid level through the flow and the cross-sectional area of the container, or also convert the same into a liquid level through the hydraulic data collected by a pressure sensor; since the pressure at the bottom of the liquid is directly proportional to the liquid level, the liquid level detection module preferably uses a liquid level sensor 4, and the liquid level sensor is connected to the controller. The liquid level sensors are preferably two in number, one being installed at a higher end of the container for detecting the highest water level, and one being installed at a lower end of the container for detecting the lowest water level; a flow sensor 1 is provided at the water outlet pipe, and the flow sensor is connected to the controller. A magnetic levitation reverse water collector 9 is provided at the bottom of the filter element, and the magnetic levitation reverse water collector is located outside the filter element. When water is provided, the magnetic levitation reverse water collector closes the pipeline of the magnetic levitation reverse water collector under the action of buoyancy; when no water is provided, the channel is opened, and impurities are discharged from the pipe orifice.

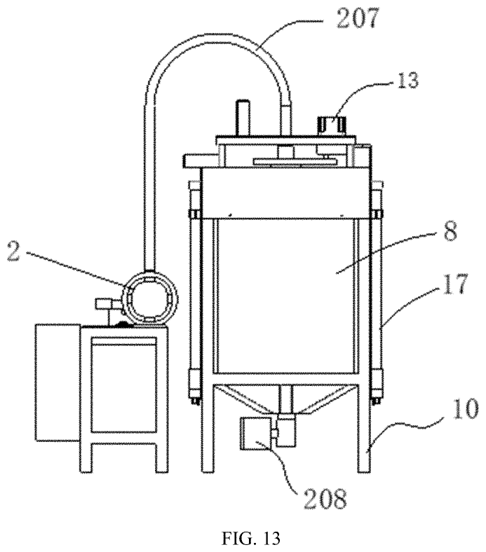

An intelligent water treatment system is formed by cascading multiple barrel-type water treatment devices having an external liquid pump and a rotary filter element; the barrel-type water treatment device having an external liquid pump and a rotary filter element is the above-mentioned barrel-type water treatment device having an external liquid pump and a rotary filter element; see FIGS. 13-15.

The cascade refers to that the waste water pumped by the liquid pumping mechanism of the previous stage enters the liquid inlet pipe of the next stage or enters the liquid inlet pipe of the next stage after being buffered by an intermediate tank; in addition, a flocculating agent is added before the water treatment in each stage of the barrel-type water treatment device having an external liquid pump and a rotary filter element.

Process Description:

when the water enters, the waste water ejects from the water outlet hole to clean the outer wall of the filter element, and the water outlet hole is designed to be inclined at a certain angle, so that the cleaning effect is better than before. In particular, the angle of inclination is 1-30 degrees, preferably 10-20 degrees, such that the angle of the outlet water deviates from the radial direction by a certain angle, such as 10-20 degrees.

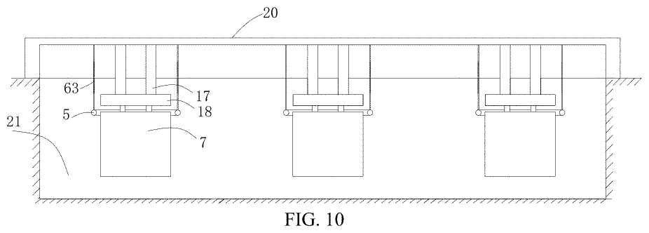

In addition, as shown in FIG. 10, multiple filter elements are provided in the container; multiple filter elements are controlled synchronously. Namely, the following steps: synchronously feeding water, synchronously lifting and lowering, and it being possible for simultaneously pumping water and sharing a waste device.

(II) An Intelligent Water Treatment System

An intelligent water treatment system is formed by cascading multiple water treatment devices; the water treatment device is the above-mentioned barrel-type water treatment device having an external liquid pump and a rotary filter element;

The cascade refers to that the waste water pumped by the liquid pumping mechanism of the previous stage enters the liquid inlet pipe of the next stage or enters the liquid inlet pipe of the next stage after being buffered by an intermediate tank; in addition, a water treatment agent (such as flocculating agent, etc.) is added before the water treatment in each stage of the barrel-type water treatment device having an external liquid pump and a rotary filter element.

(III) An Electrically Controlled System of a Barrel-Type Water Treatment Device Having an External Liquid Pump and a Rotary Filter Element (an Electrically Controlled System Based on MCU)

An electrically controlled system of an intelligent water treatment device comprises an MCU, a position sensor, and a liquid level sensor;

both the position sensor and the liquid level sensor are connected to the MCU; the lifting mechanism, liquid inlet valve, agent administration mechanism, material discharge valve, and liquid pump are all controlled by MCU;

the position sensor is used for detecting the position of the lifting platform or the filter element in the vertical direction;

the liquid level sensor is used for detecting the height of the liquid level in the container;

the MCU has a timing unit therein for controlling the reaction time (such as the flocculation time).

The MCU executes the following controls.

Water feeding and administration control, wherein the MCU controls the opening of the water inlet valve, and when the liquid level rises to a preset liquid level, water feeding is stopped;

when water enters, the agent for purifying water enters the container at the same time as the water to be treated; it can enter the container in the form of a mixture, and in that way, one liquid inlet valve can control, and the agent administration pipe and the waste water inlet pipe are pre-separated, and the mixing of the agent and the waste water is completed only when water enters; it is also possible for the water and the medicine to enter in different pipelines, but the medicine addition and the water addition are performed simultaneously.

Filter Element Lift Control

The MCU controls the rising of the filter element to clean the outer wall of the filter element at the same time when water enters; after the position sensor detects that the filter element rises to a predetermined highest position, the filter element is stopped from rising;

after the predetermined reaction time is reached, the MCU controls the filter element to lower; the filter element is stopped form lowering when reaching a predetermined lower limit position;

Water Pumping Control

When the filter element is lowered to a set position (such as the lowest position, or a lower position), the MCU starts a liquid pump to start pumping water; after the liquid level meter detects that the liquid level is lower than a certain set value or a flow meter detects that the flow is lower than the set value, the MCU turns off the liquid pump.

Waste Discharging Control

After the liquid level meter detects that the liquid level is lower than a certain set value or the flow meter detects that the flow is lower than the set value, the material discharge valve is opened to discharge the waste; the material discharge valve is closed after a predetermined material discharge time, after a predetermined material discharge time T2, or after detecting by a weight sensor that the weight of waste at the bottom of the container is less than a predetermined value; the next control cycle is restarted;

if the flow meter is used for water output detection, the flow meter is provided at the water outlet pipe, and the flow meter is connected to the MCU.

The Rotation Control of a Filter Element

The filter element is a rotary filter element, a bearing is provided on the lifting platform, and a rotary shaft of the filter element is inserted in the bearing; the intelligent water treatment device further comprises a motor and a transmission mechanism; the motor drives the filter element to rotate via the transmission mechanism;

the control executed by the MCU also comprises the control of the motor;

during the process when the filter element rises, the motor is started to drive the filter element to rotate, and at this time, the water ejected from the annular water inlet pipe flushes the outer wall of the filter element, so as to enhance the cleaning effect.

The electrically controlled lifting driving mechanism is a hydraulic push rod or an electric push rod.

The MCU is a single chip microcomputer, FPGA, CPLD, DSP, or ARM processor.

The intelligent water treatment device further comprises a communication module; the MCU is connected to a communication module, and the MCU is connected to a remote control terminal or a control center via the communication module. If multiple intelligent water treatment devices are provided in one container, the multiple intelligent water treatment devices are synchronously controlled.

The position sensor is at least one of a travel switch, a displacement sensor, and a photoelectric sensor.

The description of the working process (the specific control is the existing mature control technology):

step 1: water feeding and administration, and filter element rising;

wherein the MCU controls the opening of the water inlet valve, and when the liquid level rises to a preset liquid level, the water inlet is stopped; when water enters, the agent for purifying water enters the container at the same time as the water to be treated;

the MCU controls the rising of the filter element to clean the outer wall of the filter element at the same time when water enters; after the position sensor detects that the filter element rises to a predetermined highest position, the filter element is stopped from rising;

step 2: water purification reaction;

wherein when the liquid level rises to a preset liquid level, it stills set time T1, allowing the agent in the water to fully function; if it is sufficient, the flocculation reaction is generated;

step 3: lowering the filter element and water pumping;

wherein after the predetermined reaction time is reached, the MCU controls the filter element to lower; the filter element is stopped form lowering when reaching a predetermined lower limit position;

when the filter element is lowered to a set position (such as the lowest position, or a lower position), the MCU starts a liquid pump to start pumping water; after the liquid level meter detects that the liquid level is lower than a certain set value or a flow meter detects that the flow is lower than the set value, the MCU turns off the liquid pump;

step 4: discharging the waste;

wherein after the liquid level meter detects that the liquid level is lower than a certain set value or the flow meter detects that the flow is lower than the set value, the material discharge valve is opened to discharge the waste; after the waste is discharged for time T2, T2 being the predetermined material discharge time, or after detecting by a weight sensor that the weight of waste at the bottom of the container is less than a predetermined value, the material discharge valve is closed; the next control cycle is restarted;

step 1 is returned to enter the next cycle after the material discharge is completed, until the intelligent water treatment device is turned off (e.g. manually, or by malfunction, or by remote control).

The filter element is a rotary filter element, a bearing is provided on the lifting platform, and a rotary shaft of the filter element is inserted in the bearing; the intelligent water treatment device further comprises a motor and a transmission mechanism; the motor drives the filter element to rotate via the transmission mechanism;

during the process when the filter element rises, the MCU starts the motor to drive the filter element to rotate, and at this time, the water ejected from the annular water inlet pipe flushes the outer wall of the filter element, so as to enhance the cleaning effect.

A remote control method can be used to control the water treatment process of the intelligent water treatment device, and the specific control method is the prior art; the MCU is communicatively connected to a remote control terminal or a remote control center via a communication module to realize remote control. The remote control terminal may be a PC or a smartphone, and the remote control center may be a server.

(IV) An Electrically Controlled System of a Barrel-Type Water Treatment Device Having an External Liquid Pump and a Rotary Filter Element (an Electrically Controlled System Based on the Traditional Relay Protection)

A relay control system for an intelligent water treatment device, comprising a water inlet control circuit, a filter element lifting control circuit, a liquid pump control circuit, and a discharge control circuit; the relay control system further comprises a start button, a stop button, a first time delay relay, a second time delay relay, an upper liquid level detection circuit and a lower liquid level detection circuit, an upper limit detection circuit (such as an upper limit switch) and a lower limit detection circuit (such as a lower limit switch); the first time delay relay is used for controlling the reaction time; the second time delay relay is used for controlling the discharge time.

(1) Control Circuit for Water Feeding and Administration

The water feeding control circuit is connected to the start button, the stop button, the second time delay relay switch, the upper liquid level detection circuit, and a water inlet valve relay; when the start button is pressed or the second time delay relay switch is closed, the water inlet valve is opened; when the stop button is pressed or the upper liquid level detects that the liquid level reaches the preset upper limit height, the water inlet valve is closed; when the water inlet valve is opened, the agent administration mechanism is simultaneously activated, and when the water inlet valve is closed, the agent administration mechanism is simultaneously closed.

(2) Control Circuit for Filter Element Lifting

The control circuit for filter element lifting is used for driving the lifting platform to rise and lower via an electrically controlled lifting mechanism; the control circuit for filter element lifting is connected to the electrically controlled lifting mechanism, the start button, the stop button, the upper limit detection circuit, the lower limit detection circuit, and the second time delay relay switch; when the start button is pressed, the filter element rises; when the stop button is pressed, the filter element stops operating; when the upper limit detection circuit detects that the filter element reaches the upper limit position, the rising is stopped; when the lower limit detection circuit detects that the filter element reaches the lower limit position, the lowering is stopped; when the second time delay relay switch operates, it indicates that the reaction is completed and the filter element starts to lower.

(3) Discharge Control Circuit

The discharge control circuit is connected to the lower liquid level detection circuit, the second time delay relay switch, the discharge valve relay, and the second time delay relay; when the lower liquid level detection circuit detects a first lower limit liquid level of the liquid level, the discharge valve relay is started to drive the discharge valve to open; simultaneously the second time delay relay is started; when the second time delay relay switch operates, it indicates that discharging is completed, and the discharge control circuit drives the discharge valve relay to lose power so as to close the discharge valve.

A relay control system for an intelligent water treatment device, further comprises a control circuit for filter element rotation;

the control circuit for filter element rotation is used for controlling the motor to rotate or stop rotating via a relay;

the control circuit for filter element rotation is connected to a motor power supply relay, a start button, a stop button, a second time delay relay switch, and an upper limit detection circuit; when the start button is pressed, or when the second time delay relay switch is closed (indicating that the material discharging is completed), the motor is started, that is, the motor is started through a motor supply relay, thereby driving the filter element to rotate; when the stop button is pressed or the upper limit detection circuit detects that the filter element rises to the upper limit position, the motor is stopped from rotating by the relay, and the filter element stops rotating.

The upper limit detection circuit and the lower limit detection circuit use a photoelectric sensor, a magnetic sensor, or a limit switch (travel switch).

The upper liquid level detection circuit and the lower liquid level detection circuit use a liquid level sensor and a comparator (or an amplifier).

The electrically controlled lifting mechanism is an electric push rod or a hydraulic push rod.

The water feeding control circuit, the control circuit for filter element lifting, the liquid pump control circuit, the control circuit for filter element rotation, and the discharge control circuit use PLC or discrete logic devices (in combination with NOR gate).

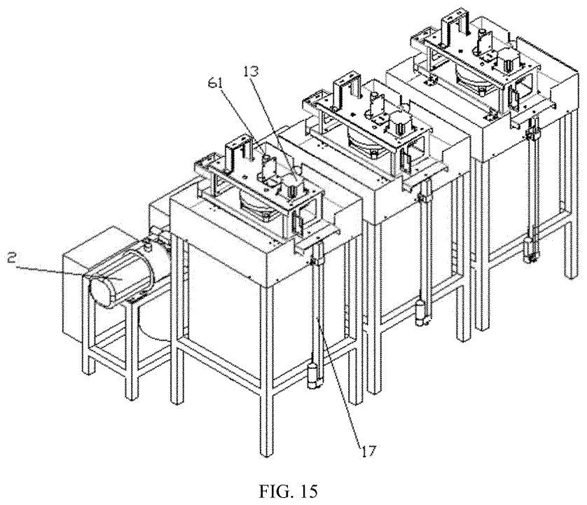

See FIG. 15 for a specific water treatment process flow.

(V) The Specific Filter Element Structure

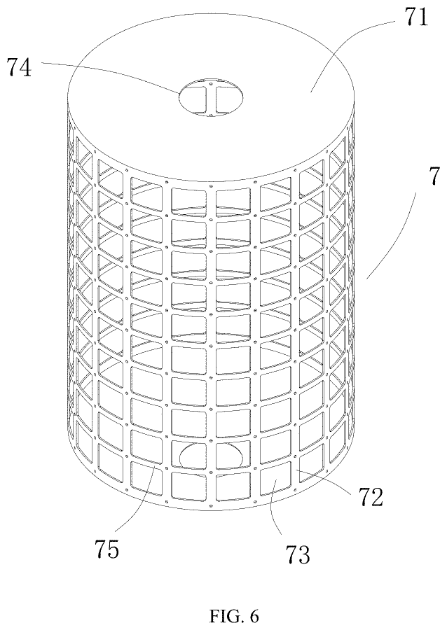

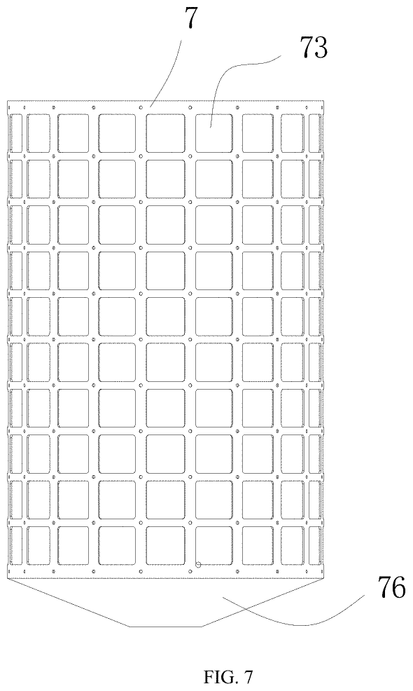

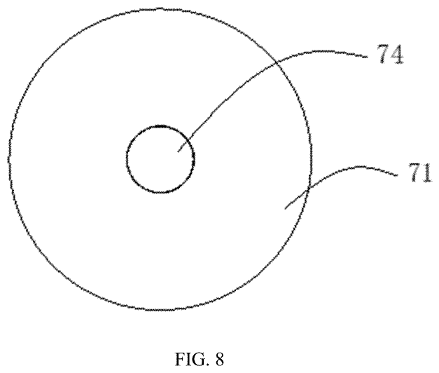

As shown in FIGS. 6-8, a filter element for a waste water treatment device comprises an outer frame of a filter element and a filter screen; the central pipe is inserted and fixed in the middle of the outer frame of the filter element; the central pipe is located in the central cavity of the outer frame of the filter element; the filter screen covers and is fixed to the outer periphery of the outer frame of the filter element, and multiple filter holes are provided on the filter screen; the bottom of the filter element is provided with a sealed barrel bottom; the bottom of the barrel is butt-jointed to the lowest end of the outer frame; a seal is maintained between the lower end of the filter screen and the upper end of the barrel bottom;

the side part of the outer frame of the filter element has multiple orifices 73;

the outer frame is cylindrical; the rotary filter element further comprises an upper cover, and the upper cover is abutted with the upper end of the filter element housing; the upper cover and the barrel bottom are both provided with a mounting hole 74, and the central pipe is inserted and installed in two mounting holes and fixed; a seal is maintained between the outer wall of the rotary shaft and the mounting hole of the bottom of the barrel to prevent the water in the rotating filter element from flowing out of the filter element.

The lower end of the central pipe is located between the bottom of the outer frame of the filter element and the bottom of the barrel, and the rotary shaft is hollow; the lower end of the central pipe has at least one water inlet hole 77; a water pumping pipe 3 is provided in the central pipe. 2 to 4 water inlet holes are preferred.

The bottom of the central pipe is sealed or provided with a magnetic levitation reverse water collector. The lower end of the rotary shat is sealed or semi-sealed. The semi-sealed means that the bottom of the rotary shaft is provided with a magnetic levitation reverse water collector, and when there is water in the outer barrel, the upper top of a floating ball in the magnetic levitation reverse water collector is sealed under the buoyancy of the water.

The filter element is connected to the lifting platform 18 via a lifting driving mechanism.

The filter screen can be a common filter screen, such as a steel wire filter screen, or a nylon filter screen, etc. Such a common filter screen can be used, but there is a problem of insufficient strength.

The filter screen preferably has an etched filter hole thereon; the filter screen and the filter hole formed on the basis of an etching technique can be very fine and uniform; according to requirements, the diameter of the filter hole can be designed to be different sizes, and the density of the holes can be set according to requirements; if only coarse filtration is required, the filter hole can be designed to be relatively large, such as millimeters; if fine filtration is desired, the filter hole can be made relatively small, with a diameter on the order of 0.1 mm. The advantage is that the overall strength is higher than that of a regular filter screen.

The orifices on the side part of the outer frame of the filter element are uniformly arranged. That is, it is an equidistant array arrangement.

The orifices 73 on the side part of the outer frame of the filter element are at least one or a mixture of a rectangle, a square, a parallelogram, a regular pentagon, a regular hexagon, or a regular octagon. A mixture means that two or more kinds of holes are mixedly arranged, such as partial squares, partial regular hexagons, and the scenarios that the square can be a square that is set forward or a square that is placed slantly.

The outer frame of the filter element is an integral outer frame, for example, a frame net having a rectangular shape is used, and the front and rear (or left and right) are butted and welded together to form one cylindrical frame body.

The filter element has the following features:

(1) a double-layer structure with a rotary shaft is adopted as a whole, the inner layer is a frame, the outer layer is a filter screen, and the frame, the barrel cover and the barrel bottom can jointly fix the central pipe; therefore, the structure is compact and the sealability is good;

(2) the water suction pipe is provided in the central pipe, with a more beautiful appearance;

(3) when the magnetic levitation reverse water collector is used, the water suction pipe is closed when there is water at the bottom, and when there is no water at the bottom, impurities in the water suction pipe can be discharged, providing a prominent effect;

(4) in combination with the lifting mechanism and the water spraying structure, the automatic cleaning of the outer wall can be realized;

In view of the above, the filter element of the barrel-type water treatment device having an external liquid pump and a rotary filter element is compact in structure and beautiful in appearance, and is a key mechanism in the water treatment device.

(VI) Lifting Driving Mechanism

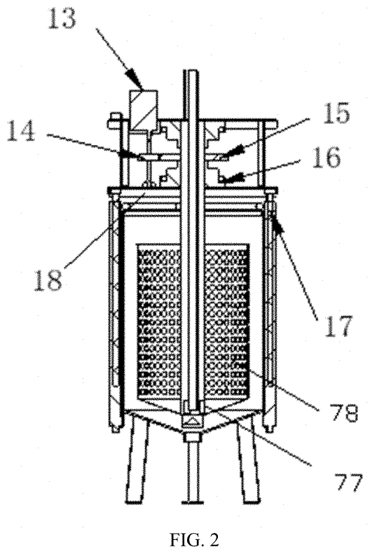

Case 1: as shown in FIGS. 2-4, the stationary part (lower end) of the driving mechanism is directly fixed to the outer barrel; the moving end (upper end) is connected to the lifting platform; it is used for driving the filter element to rise and lower.

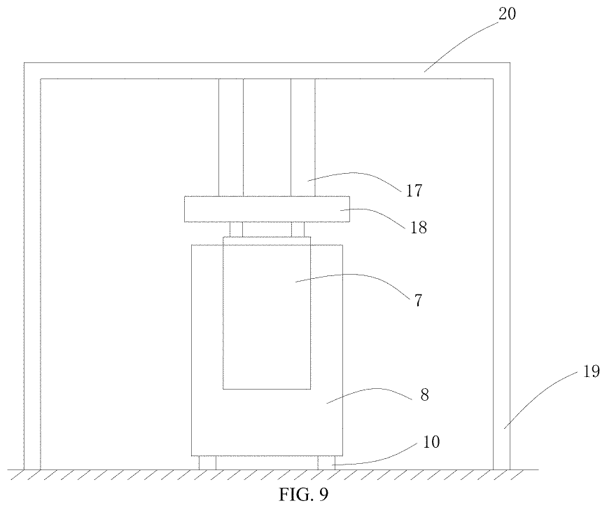

Case 2, as shown in FIG. 9, a filter element lifting mechanism of a barrel-type water treatment device having an external liquid pump and a rotary filter element is shown, wherein the outer barrel diameter is large so such a lifting mechanism can be used; the first end (the stationary end) of the electrically controlled lifting driving mechanism is fixed to the cross beam 20 of the support 19, and the movable end (the lower end) is connected to the lifting platform. The lifting platform is connected to the filter element for driving the filter element to rise and lower.

Case 3: as shown in FIG. 10, a filter element lifting mechanism of a barrel-type water treatment device having an external liquid pump and a rotary filter element is shown, the container being a settling tank; therefore, the device is suitable for treating a large amount of waste water at one time; multiple groups of the electrically controlled lifting driving mechanisms are provided, and the first end (the stationary end, the upper end) of each group of electronically controlled lifting and lowering drive mechanisms is fixed to the beam 20. The movable end (the lower end) is connected to the lifting platform, so as to realize the synchronous rising and lowering of multiple filter elements. Multiple vertical rods are used for fixing the annular water inlet pipe. The upper end of the vertical rod fixes a cross beam and the lower end fixes the annular water inlet.

(VII) Liquid Inlet Pipe (Water Inlet Pipe)

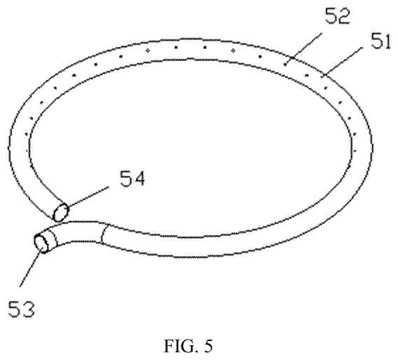

As shown in FIG. 5, for a water inlet pipe in a water treatment device, the pipe body 51 of the water inlet pipe is generally in a surrounding shape; the pipe body outer end 54 of the water inlet pipe is closed off; multiple water outlet holes 52 are provided on the water inlet pipe; the water treatment device has an inner barrel and an outer barrel.

The water outlet hole is located at the inner side of the outer-winding-shaped pipe body such that the direction of the water ejected from the hole is in a central direction (such as a radial direction and pointing towards the center of a circle), and cheap at a certain angle (such as 15 degrees) so that the inner barrel can be washed easily when the water enters.

The overall shape of the pipe body is annular, and the diameter of the inner ring of the pipe body is greater than the outer diameter of the inner barrel.

The pipe body is fixed to the inner wall of the opening of the outer barrel by welding or by multiple hooks.

The overall shape of the pipe body is a regular quadrilateral, which can be adapted to a square filter element; furthermore. It can be a regular n-gon, n being greater than or equal to 5, so as to adapt to the shape of the filter element, so that the function of cleaning the outer wall of the filter element can be better played.

Multiple water outlet holes are arranged at equal intervals.

The diameter of the water outlet hole ranges from 2 to 20 mm. Depending on the volume of the water treatment device, it is preferable that the diameter of the annular pipe body is 430 mm and the diameter of the water outlet hole is 2.5 mm.

The water inlet pipe has the following features:

(1) one end of the pipe body is blocked, and water is discharged through a small water outlet hole, and therefore, the water outlet is more uniform than that of a direct pipe opening;

(2) the water outlet holes are arranged at equal intervals, and the water outlet is more uniform;

(3) when an annular pipe body is used, and the water outlet hole faces towards a circle, during the lifting process of the inner barrel (namely, the filter element), the water outlet can flush the outer wall of the inner barrel to play a self-cleaning role;

(4) as a whole, the ring or polygon structure is adopted, making the appearance more beautiful.

In view of the above, the water inlet pipe used in the water treatment device has an attractive structure and a self-cleaning function.

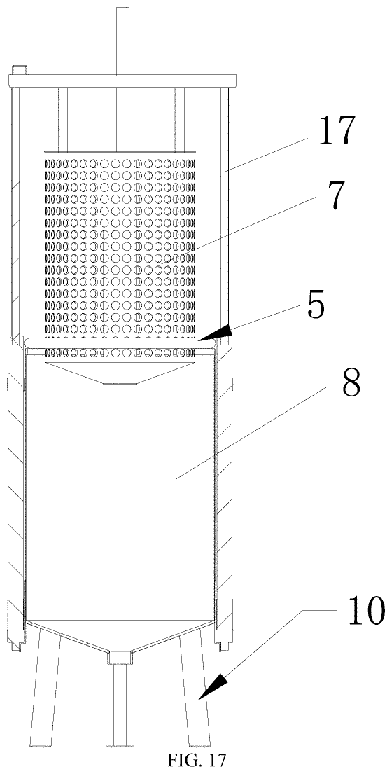

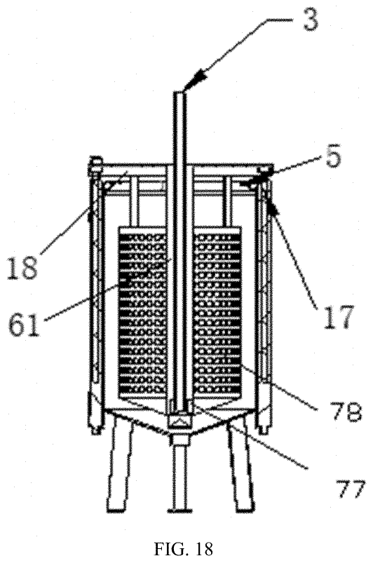

Another type of annular water inlet pipe is as shown in FIGS. 17 and 18. The water inlet pipe is an annular pipe without a notch, and the inner cavity of the annular pipe is in communication with the water inlet end of the water inlet end, namely, one circular hole is opened on the annular pipe, and is butt-jointed to the water inlet pipe (generally butt-jointed by welding).

The agent is administrated through an agent administration mechanism. The agent is administrated simultaneously with the addition of water preferably through an additional tube, a solution with the agent being preferred. The agent liquid entering or stopping entering is controlled through a valve; or the solid or powdered agent is directly administrated, an agent administration mechanism being shown in the picture.

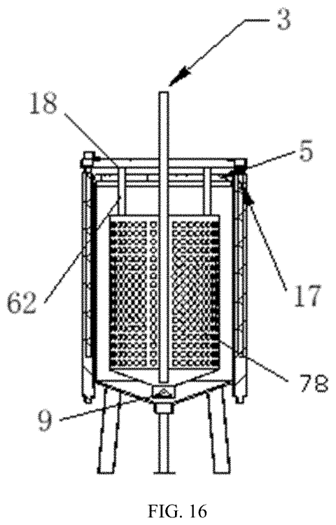

As shown in FIGS. 16-18, the filter element itself does not rotate, and there is no need for a filter element rotation driving mechanism; the filter element is directly fixed to the lifting platform via a connecting rod; the other working processes are the same as those of the equipment of embodiment 1 (only that the filter element rotation driving mechanism, bearings, etc. are eliminated in the solution of embodiment 1). The detailed description is as follows:

the barrel-type water treatment device comprises a container, a filter element 7, a filter element lifting mechanism, a liquid inlet pipe 5, an agent administration mechanism, a liquid pumping mechanism, and a material discharge mechanism; the container is an outer barrel 8; the liquid outlet of the administration mechanism is provided on the container for putting the water treatment agent into the container; a filter element is placed in the container; the filter element is a barrel-type device, and multiple filter holes are provided on a barrel wall of the filter element; the filter element lifting mechanism comprises a lifting platform and an electrically controlled lifting driving mechanism for driving the lifting platform to perform lifting movement; the filter element is fixed to the lifting platform; the lifting of the lifting platform can drive the filter element to lift synchronously; the fixation may be completely fixed, or some looseness may be maintained. The liquid inlet pipe is fixed in the container; the liquid inlet pipe is used for introducing water to be purified and a water treatment agent into a container, and a liquid inlet valve is provided on a liquid supplying pipeline of the liquid inlet pipe; the liquid pumping mechanism comprises a liquid pump (2) and a water pumping pipe (3) connected to the liquid pump, wherein the lower end of the water pumping pipe is located at the bottom in the filter element for pumping out the treated water in the filter element; the liquid pump is preferably a self-suction water pump; the material discharge mechanism comprises a discharge pipe (12) arranged at the bottom of the outer cylinder for discharging wastes, and a material discharge valve (11) arranged on the discharge pipe; the liquid pump is an external liquid pump; the container is provided therein with a detection module for detecting the liquid volume or liquid level in the container. The intelligent water treatment device further comprises a control module, wherein the control module is used for controlling the actions of a filter element lifting mechanism, a liquid inlet valve, an agent administration mechanism, a liquid pumping mechanism, and a material discharge valve. The detection module is connected to the control module for transmitting the detection result to the control module. The specific control module and control method are the prior art. The liquid pump is provided on the ground outside the outer barrel, or on a support provided on the ground. The liquid level detection module can directly use a liquid level sensor, or use other sensors to convert the same into a liquid level, such as using a flow meter at the water inlet pipe, converting the same into the liquid level through the flow and the cross-sectional area of the container, and also converting the same into the liquid level through the hydraulic data collected by a pressure sensor, because the pressure at the bottom of the liquid is directly proportional to the liquid level; preferably a liquid level sensor is used; the liquid inlet pipe is an annular pipe, and the pipe wall of the annular pipe is provided with multiple water outlet holes; the administration (water treatment agent) and water feeding are performed simultaneously, entering through different water pipes and mixing at the inlet of the liquid inlet pipe; the diameter of the inner ring of the annular pipe is greater than the outer diameter of the filter element; it is ensured that the filter element can rise and lower on the annular pipe so that the effluent of annular pipe can clean the outer wall of filter element.

The container is an outer barrel or a water treatment tank; the electrically controlled lifting driving mechanism is fixed to the container or on the ground outside the container or on a support. The electrically controlled lifting driving mechanism comprises a stationary part and a moving part; in operation, the stationary part does not operate, and the moving part telescopically operates, which means that the stationary part is fixed;

two electrically controlled lifting mechanisms are provided so that the lifting movement is smoother and more stable. The electrically controlled lifting driving mechanism is an electric push rod, and the stationary end (the lower end) is fixed to the outer wall of the outer barrel.

A magnetic levitation reverse water collector 9 is installed at the bottom of the inner barrel; when there is water, the magnetic levitation reverse water collector closes the pipeline of the magnetic levitation reverse water collector under the effect of buoyancy; when there is no water, the channel is opened, and impurities are discharged from the pipe orifice.

A position detection module for detecting the position of the filter element lifting mechanism is provided in the container or on the filter element lifting mechanism.

The position detection module employs a position sensor as at least one of a photoelectric sensor, magnetic sensor energy, a displacement sensor, and a travel switch.

The connecting mode between the filter element and the lifting platform is as follows:

mode 1: the filter element is connected to the lifting platform via connecting rod 62;

mode 2: the filter element is connected to the lifting platform via the central pipe 61; the axis of the central pipe coincides with the axis of the filter element;

mode 3: the filter element is connected to the lifting platform via the central pipe 61 and the connecting rod 62, and the axis of the central pipe coincides with the axis of the filter element;

in addition, as shown in FIG. 13, multiple filter elements are provided in the container; multiple filter elements are controlled synchronously. Namely, the following steps: synchronously feeding water, synchronously lifting and lowering, and it being possible for simultaneously pumping water and sharing a waste device.

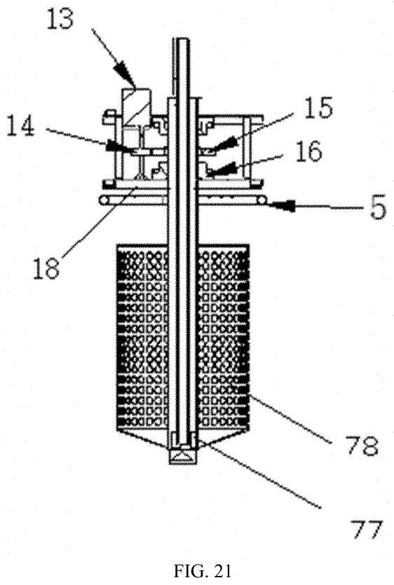

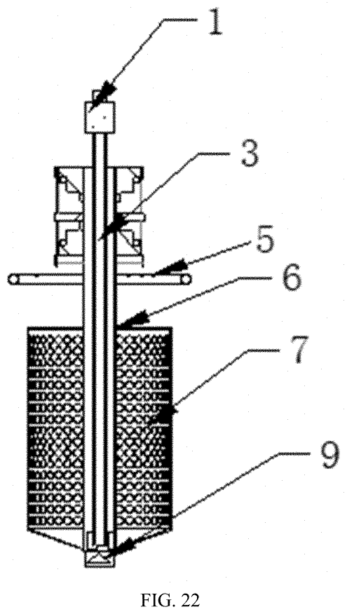

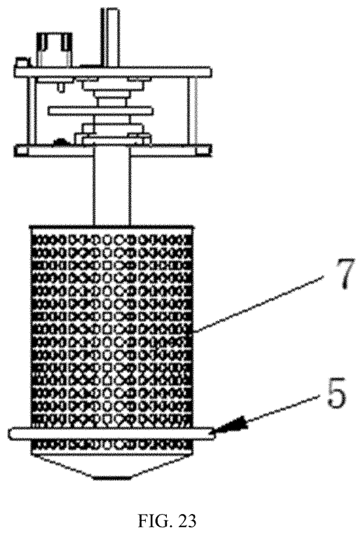

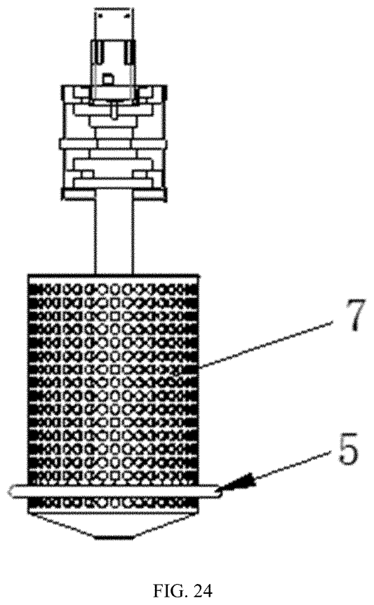

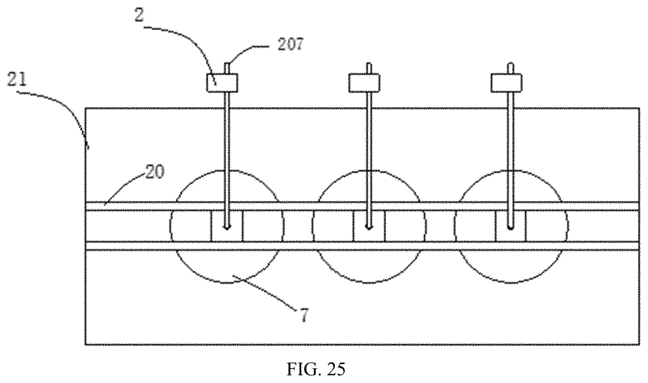

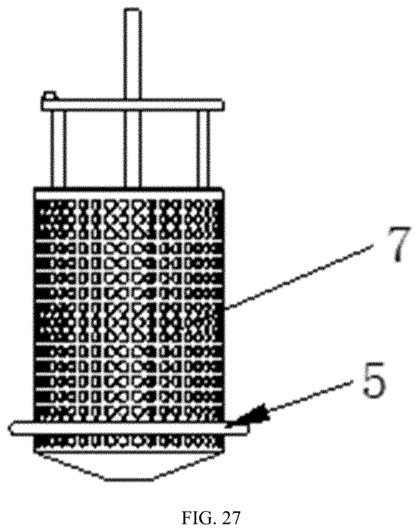

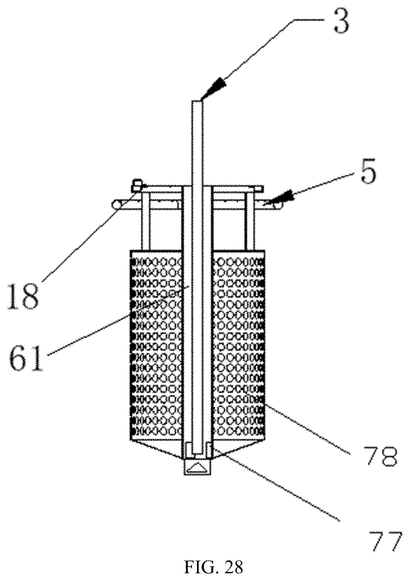

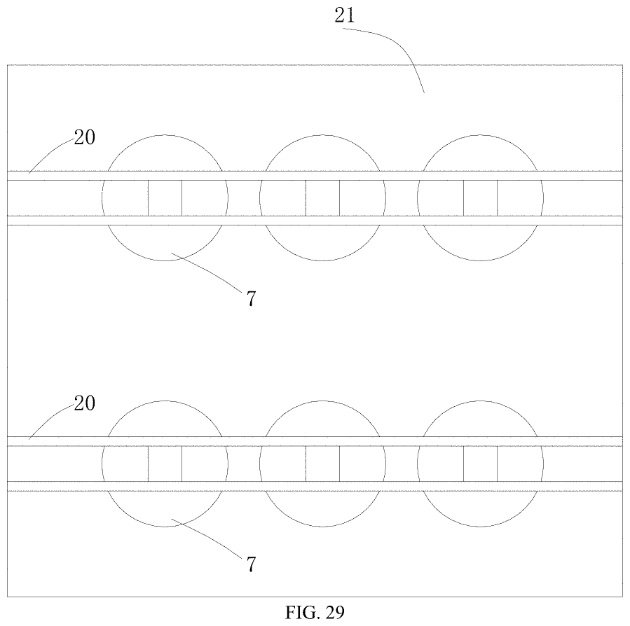

As shown in FIGS. 21-29, a sewage treatment device comprises a container (21), a support, a lifting water treatment unit, a liquid inlet mechanism, an agent administration mechanism, and a material discharge mechanism; at least one lifting water treatment unit is provided to hang on a support; the support is located above the container; the liquid inlet mechanism is used for introducing the sewage to be treated into the container, and a liquid inlet valve is provided on a liquid supplying pipeline of the annular water inlet pipe; an agent administration mechanism is used for administrating the water treatment agent into the container; a material discharge mechanism is used for discharging waste at the bottom of the container; the material discharge mechanism comprises a discharge pipe and a material discharge valve provided on the discharge pipe; the inlet of the discharge pipe is arranged at the bottom of the container; the lifting water treatment unit comprises a filter element, a filter element lifting mechanism, and a liquid pumping mechanism; the filter element is placed in the container; the filter element is hollow, and the outer wall is provided with multiple filter holes, and the filter element is used for filtering clear liquid from the container into the filter element; the filter element lifting mechanism comprises a lifting platform and an electrically controlled lifting driving mechanism (17); an electrically controlled lifting driving mechanism serves as a connecting mechanism between the support and the lifting platform; the electrically controlled lifting driving mechanism is used for driving the lifting platform to rise and lower; the filter element is installed on the lifting platform; the liquid pumping mechanism comprises a liquid pump (2) and a water pumping pipe (3) connected to the liquid pump, wherein the lower end of the water pumping pipe is located at the bottom of the filter element for pumping out the clear liquid in the filter element; the sewage treatment device further comprises a liquid level detection module for detecting the liquid level of the container; the sewage treatment device further comprises a control module, wherein the control module is used for controlling the actions of the filter element lifting mechanism, the liquid inlet mechanism, the agent administration mechanism, the liquid pumping mechanism, and the material discharge valve; the container is a box or a tank.

The number of both the lifting water treatment units and liquid inlet mechanisms is N, N being an integer, and N≥1.

The sewage treatment device according to claim 2 is provided, characterized in that the liquid inlet mechanism is an annular water inlet pipe, and multiple water outlet holes are provided on the annular water inlet pipe; an annular water inlet pipe is located at the opening of the container; the diameter of the annular water inlet pipe is greater than the outer diameter of the filter element; the annular water inlet pipe is fixed below the support via a vertical rod (63); when the filter element rises, the filter element can pass up through the annular water inlet pipe, so that the liquid ejected from the annular water inlet pipe can flush the outer wall of the filter element when the filter element rises. The filter element is a cylindrical filter element.

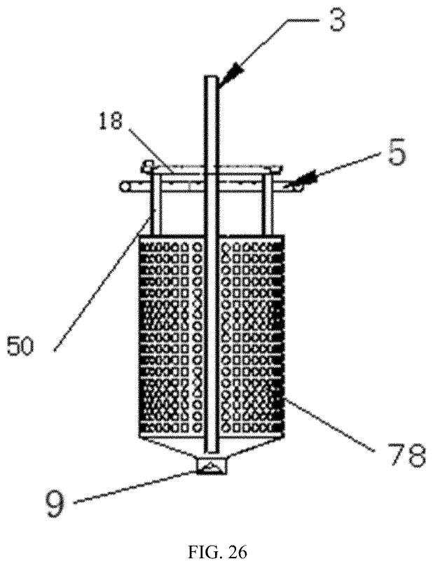

As shown in FIGS. 21-24, the filter element of the water treatment unit is a rotary filter element; as shown in FIGS. 26-28, the filter element of the water treatment unit is a fixed filter element.

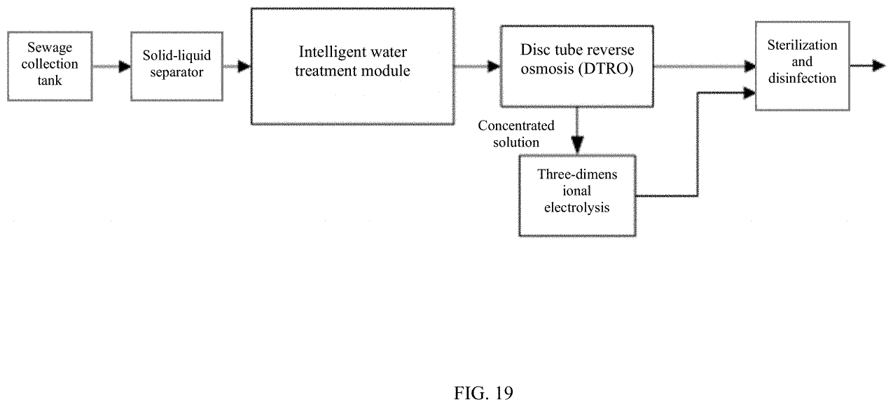

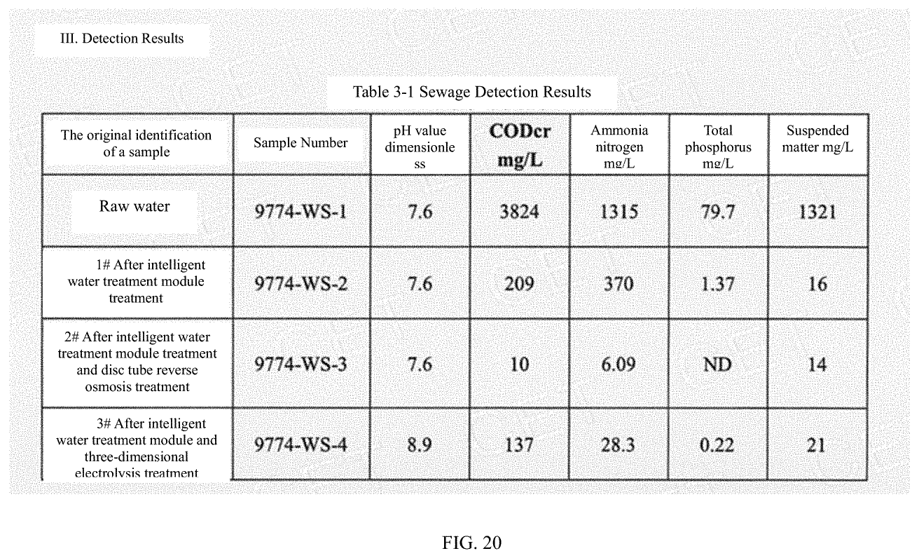

As shown in FIGS. 19 and 20, the solution for butting the sewage treatment device (module) of the present disclosure with other advanced treatment processes is as follows:

an integrated sewage treatment system comprises a flocculation device, a DTRO device, and a three-dimensional electrolysis device. The water inlet of the DTRO device is connected to a water outlet of the flocculation device; the water inlet of the three-dimensional electrolysis device is connected to the concentrated liquid discharge outlet of the DTRO device; the flocculation device is used for flocculating, precipitating, and clearing the sewage; (clearing means draining the clear liquid); the DTRO device is a disc tube reverse osmosis membrane device for further purification treatment of the clear liquid output from the flocculation device.

The three-dimensional electrolysis device further processes the concentrated solution from the DTRO device. The purified water output from the three-dimensional electrolysis device is integrated with the purified water output from the DTRO device and then discharged. Integrating means mixing. After the integration, the indicators meet the relevant emission standards. Further, a sterilizing and disinfecting device is included; the sterilizing and disinfecting device butt-joints with the integrated drainage end. Further, a solid-liquid separator is included; the solid-liquid separator butt-joints with the inlet of the flocculation device, and the liquid output from the solid-liquid separator enters the flocculation device. The flocculation device is an intelligent water treatment device. The flocculation device can also be other flocculation devices that are not intelligent, such as adding a flocculating agent into a sewage tank, stirring and reacting and precipitating, and then taking the supernatant liquid for further treatment.

The intelligent water treatment device also includes a preceding-stage filtration module. A control module is included. The control module controls the operation of the intelligent water treatment device, the DTRO device, and the three-dimensional electrolysis device. A communication module is connected to the control module, and the communication module is used for transmitting the field data to a remote receiving end. The remote receiving end is equipment such as a server or a smart phone.

By regulating the DTRO device, the amount of concentrated solution is minimized, so as to reduce the power consumption of three-dimensional electrochemical operation and achieve the economic efficiency of the system.

The intelligent water treatment device is also called an intelligent water treatment module, because it can be arranged in a modular manner, can be arranged independently, or can be arranged in parallel.

The introduction of two advanced treatment processes is given below.

(1) DTRO (Disc Tube Reverse Osmosis) Treatment Process:

technical introduction: reverse osmosis technology is a membrane separation technology that separates the solvent from the solution with pressure difference as the driving force; a terminal process typically used for water treatment;

advantages: the equipment has a small size, simple operation, stable operation, and strong adaptability;

disadvantages: the equipment cost is high, and 10-30% of high concentration water needs to be further treated by other processes.

DTRO Effect:

the removal rate of COD is 90% and more (reducing from 209 mg/L to 10 mg/L measured in a case);

the removal rate of ammonia nitrogen is 90% and more (reducing from 370 mg/L to 6.09 mg/L measured in a case);

the role of DTRO in the whole water treatment system:

since the SS indicator and other indicators of the preceding-stage treatment have been reduced to extremely low, the use of this stage of reverse osmosis treatment can significantly improve the service life of the equipment.

(2) Three-Dimensional Electrolytic Treatment Process:

process introduction: hydrogen peroxide and hydroxyl free particles generated by electrolysis are used to oxidatively degrade pollutants in the water, which could effectively reduce COD, ammonia nitrogen, and chroma removal;

advantages: modular treatment, widely used, small area occupation, simple operation, no need to add agents;

after only 10 minutes, the COD can be reduced by 60% and more, and the total removal rate of COD of the system can reach 95% and more; the removal rate of ammonia nitrogen can reach 95% and more;

disadvantages: high energy consumption and short service life of an electrode;

the role of the three-dimensional electrolytic treatment process in the whole water treatment system is that

since the preceding-stage intelligent module processing has greatly reduced various indicators, the system using this process can greatly reduce energy consumption and operating costs. In addition, the three-dimensional electrolytic treatment process can be re-treated for the concentrated water treated by the reverse osmosis membrane.

The most beneficial effect of the present disclosure is that using a flocculation filtration device, especially a flocculation filtration device based on an intelligent water treatment module, greatly reduces various indicators of sewage (such as COD, ammonia nitrogen, etc.), and then a later advanced process (DTRO and three-dimensional electrolysis) treatment is used so that the water purification standard can be reached, thus replacing the traditional biochemical process as a whole. Compared with the traditional biochemical process where it is uncontrollable, and is greatly influenced by multiple factors such as the environment and the number of digestive bacteria administrated, the whole equipment and process of the present disclosure are completely controllable. Furthermore, because the three-dimensional electrolysis technology has almost nothing to do with the ambient temperature, it can achieve all-weather operation and completely reliable discharge that meets the standards, and the relevant indicators are far better than the relevant standards. The present disclosure perfectly integrates various technologies and achieves unexpected effects, and the practice also proves that the obtained effects are very ideal. See the following test report for details.

In addition, in particular, one ceramic membrane filter may be provided in the water treatment module and the DTRO equipment as a coarse filter, so as to extend the life of the DTRO equipment. The ceramic membrane filters are well-established mature equipment and have a low price and a long service life.

What is claimed is:

1. A sewage treatment device, comprising a container, a filter element, a filter element lifting mechanism, a liquid inlet mechanism, an agent administration mechanism, a liquid pumping mechanism, and a material discharge mechanism;
wherein the filter element is placed in the container; the filter element is hollow, an outer wall is provided with multiple filter holes, and the filter element is used for filtering clear liquid from the container into the filter element;
the filter element lifting mechanism comprises a lifting platform and an electrically controlled lifting driving mechanism; the lifting platform is connected to the filter element for driving the filter element to rise and lower; the electrically controlled lifting driving mechanism is connected to the lifting platform for driving the lifting platform to perform rising and lowering actions in the container, or to perform rising and lowering actions in the container and above the container;
the liquid inlet mechanism is used for introducing sewage to be treated into the container, and a liquid inlet valve is provided on a liquid supplying pipeline of the liquid inlet mechanism;
the agent administration mechanism is used for administrating a water treatment agent into the container, the water treatment agent is used for reacting with sewage in the container to generate floccules;
the material discharge mechanism further comprises a discharge pipe (12) provided at a bottom of the container for discharging wastes and a material discharge valve (11) provided on the discharge pipe;
the liquid pumping mechanism comprises a liquid pump (2) and a water pumping pipe (3) connected to the liquid pump, wherein a lower end of the water pumping pipe is located at the bottom within the filter element for pumping out clear liquid in the filter element;
the sewage treatment device further comprises a liquid level detection module for detecting a liquid level of the container;
the sewage treatment device further comprises a control module, wherein the control module is used for controlling actions of the filter element lifting mechanism, the liquid inlet valve, the agent administration mechanism, the liquid pumping mechanism, and the material discharge valve.

2. The sewage treatment device according to claim 1, wherein the filter element is a rotary filter element or a fixed filter element;
the rotary tilter element means that the filter element can rotate relative to the lifting platform driven by an external force; a moving direction of the electrically controlled lifting driving mechanism is the same as an axial direction of the filter element; a bearing is provided on the lifting platform, and a rotary shaft (6) of the filter element is inserted and installed on the bearing; the lifting platform is further provided with a motor (13) for driving the rotary shaft to rotate;
the fixed filter element means that the filter element is directly fixed to the lifting platform, moves synchronously with the lifting platform, and does not rotate relative to the lifting platform itself.

3. The sewage treatment device according to claim 1, wherein the liquid pump is provided on the lifting platform, or the liquid pump is an external liquid pump, the liquid pump being provided on the ground outside an outer barrel or the liquid pump being provided on a support on the ground.

4. The sewage treatment device according to claim 1, wherein the filter element is a cylindrical filter element; the liquid inlet mechanism is an annular water inlet pipe, and multiple water outlet holes are provided on the annular water inlet pipe; the annular water inlet pipe is located at an opening of the container; a diameter of the annular water inlet pipe is greater than an outer diameter of the filter element.

5. The sewage treatment device according to claim 1, wherein a stationary part of the electrically controlled lifting driving mechanism is fixed to the container, to the ground, or to an external support.

6. The sewage treatment device according to claim 1, wherein the container is an outer barrel, the bottom of the outer barrel being provided with an under-chassis (10) for supporting.

7. The sewage treatment device according to claim 1, wherein the agent administration mechanism comprises a medical solution barrel, an agent administration pipe, and an agent administration pump, wherein the agent administration pump is for pumping the liquid in the medical solution barrel into the container through the agent administration pipe, and the agent administration pump is controlled by the control module.

8. A sewage treatment device, comprising a container (21), a support, a lifting water treatment unit, a liquid inlet mechanism, an agent administration mechanism, and a material discharge mechanism;
wherein at least one lifting water treatment unit is provided to hang on the support; the support is located above the container;
the liquid inlet mechanism is used for introducing sewage to be treated into the container, and a liquid inlet valve is provided on a liquid supplying pipeline of an annular water inlet pipe;
the agent administration mechanism is used for administrating a water treatment agent into the container;
the material discharge mechanism is used for discharging waste at a bottom of the container; the material discharge mechanism comprises a discharge pipe and a material discharge valve provided on the discharge pipe; an inlet of the discharge pipe is provided at the bottom of the container;
the lifting water treatment unit comprises a filter element, a filter element lifting mechanism, and a liquid pumping mechanism;
wherein the filter element is placed in the container; the filter element is hollow, an outer wall is provided with multiple filter holes, and the filter element is used for filtering clear liquid from the container into the filter element;
the filter element lifting mechanism comprises a lifting platform and an electrically controlled lifting driving mechanism (17); the electrically controlled lifting driving mechanism serves as a connecting mechanism between the support and the lifting platform; the electrically controlled lifting driving mechanism is used for driving the lifting platform to rise and lower; the filter element is installed on the lifting platform;
the liquid pumping mechanism comprises a liquid pump (2) and a water pumping pipe (3) connected to the liquid pump, wherein a lower end of the water pumping pipe is located at the bottom within the filter element for pumping out clear liquid in the filter element;
the sewage treatment device further comprises a liquid level detection module for detecting a liquid level of the container;
the sewage treatment device further comprises a control module, wherein the control module is used for controlling actions of the filter element lifting mechanism, the liquid inlet mechanism, the agent administration mechanism, the liquid pumping mechanism, and the material discharge valve;
the container is a box or a tank.

9. The sewage treatment device according to claim 8, wherein the number of both the lifting water treatment unit and the liquid inlet mechanism is N, where N is an integer and N≥1;
the sewage treatment device according to claim 2, wherein the liquid inlet mechanism is an annular water inlet pipe, and multiple water outlet holes are provided on the annular water inlet pipe; the annular water inlet pipe is located at an opening of the container; a diameter of the annular water inlet pipe is greater than an outer diameter of the filter element;
the annular water inlet pipe is fixed below a support via a vertical rod (63); when the filter element rises, the filter element can pass up through the annular water inlet pipe, so that liquid ejected from the annular water inlet pipe can flush the outer wall of the filter element when the filter element rises;
the filter element is a cylindrical filter element.

10. The barrel-type sewage treatment system according to claim 1, comprising multiple barrel-type water treatment devices, multiple barrel-type water treatment devices being cascaded; wherein the cascaded refers to that fresh water extract from the barrel-type water treatment device of a preceding stage enters the liquid inlet mechanism of a next stage or enters the liquid inlet mechanism of the next stage after being buffered by an intermediate tank; in addition, a water treatment agent is added before water treatment in each stage of the tank-type water treatment device.
